(19) United States
(12) Patent Application Publication
(10) Pub. No.: US 2025/0382399 A1
(43) Pub. Date: Dec. 18, 2025

(54) ETHYLENE POLYMERISATION PROCESS

(71) Applicant: SABIC GLOBAL TECHNOLOGIES B.V., Bergen op Zoom (NL)

(72) Inventors: Yahya BANAT, Riyadh (SA); Lidong LI, Riyadh (SA); Nasser Abdullah ALSAIF, Riyadh (SA)

(21) Appl. No.: 18/881,092

(22) PCT Filed: Jun. 28, 2023
(86) PCT No.: PCT/EP2023/067702

§ 371 Date: Jan. 3, 2025

(30) Foreign Application Priority Data
Jul. 5, 2022 (EP) 22182970.8

(51) Int. Cl. C08F 110/02; C08F 2/34; C08F 4/659

(52) U.S. Cl. CPC C08F 110/02; C08F 2/34; C08F 4/65912; C08F 4/65916; C08F 2410/02

(57) ABSTRACT

A process for the production of ethylene-based polymers, preferably via gas-phase polymerisation, wherein the process is performed by polymerisation of a reaction composition comprising ethylene in the presence of a catalyst system, an aluminium-containing cocatalyst, an aluminium-containing cocatalyst aid, and an antistatic compound comprising one or more moieties according to formula I:

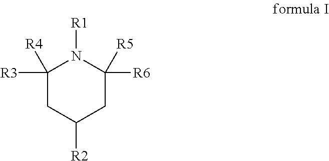

wherein:
R1 is H or an aliphatic moiety comprising 1 to 4 carbon atoms;
R4 and R5 are moieties comprising 1 to 10 carbon atoms;
R3 and R6 are H or moieties comprising 1 to 10 carbon atoms;
R2 is H; a moiety comprising 1 to 10 carbon atoms; or R2 forms a linkage to a polymeric structure wherein the compound of formula I forms a functional moiety that is bound to a polymeric chain.

### CROSS REFERENCE TO RELATED APPLICATIONS

This application is a National Stage application of PCT/EP2023/067702, filed Jun. 28, 2023, which claims the benefit of European Application No. 22182970.8 filed Jul. 5, 2022, all of which are incorporated by reference in their entirety herein.

### BACKGROUND

The present invention relates to a process for polymerisation of ethylene to produce ethylene-based homo-and/or copolymers. In particular, the invention relates to a polymerisation process wherein the occurrence of static electricity charges is reduced.

In polymerisation processes of ethylene to produce ethylene homo-and/or copolymers, continuous research and development efforts spanning across multiple decades have led to highly efficient, large-scale processes that allow for the manufacturing of ethylene-based polymers of high quality, with a very diverse array of desirable properties, under very economic conditions. In such processes, the use of various types of catalysts enables the manufacturers to produce such wide range of attractive products.

In order for such large-scale processes to operate most efficiently, it is paramount that the production process is operated with the lowest amount of interruptions, and under conditions that lead to maximum productivity of high-quality products. For example, due to the presence of impurities in the ethylene and other feed materials that are supplied to the polymerisation process, static charges may occur in the polymerisation reactors, particularly in gas-phase polymerisation processes, which can lead to disturbances in the process and, as a consequence, may lead to reactor shutdowns. It is understood that occurrence of excessive static charges in gas-phase polymerisations may lead to reactor sheeting, i.e. the deposition of polymer material onto the inner walls of a reactor. In a gas-phase reactor, polymer particles flow turbulently within the rector, driven by high superficial velocity of the gas stream. Friction and collisions between polymer particles, or between polymer particles and the reactor wall, can generate static charges on the surface of the polymer particles or the reactor wall. This phenomenon is well known in the field and termed frictional electrification or triboelectrification. When the static changes accumulate enough to overcome the pneumatic force exerted by the gas stream, the changed polymer particles may migrate to the reactor wall and finally adhere to the wall. Thus, these particles may initiate sheeting on the reactor wall. Such sheeting may lead to certain polymer particles being excessively exposed to polymerisation conditions, which ultimately may lead to carbonisations. When such carbonised particles are present in the polymer product obtained from the reactor, the quality of the polyethylene product is negatively affected. Furthermore, the presence of sheeting may lead to problems with reactor control, due to which reactor shutdowns may be necessary.

It will be understood that occurrence of such disturbances and shutdowns is to be minimised.

In ethylene polymerisation processes, use of certain types of catalysts may be more prone to such disturbances occurring. For example, catalysts of the metallocene type appear to be more sensitive to these kinds of effects. However, due to their ability to product ethylene-based polymers of very desirable properties, there is a strong desire for being able to employ catalysts of the metallocene type in ethylene polymerisation processes, whilst at the same time suppressing the occurrence of process disturbances as much as possible.

In the art, several methods have been provided attempting to alleviate the static charge in commercial olefin polymerisation reactors. In principle, three approaches are followed to reduce the static charging: reactor treatment and modification, which may involve coating the reactor inner walls using materials with less static charge generating propensity; catalyst recipe modification, enabling the catalyst to generate less static charges; and addition of antistatic additives directly into the reaction zone. Combinations of these approaches may also be used.

A particularly desirable approach is the addition of antistatic additives. This approach allows for durable and controllable suppression of the generation of static charges. However, the addition of antistatic agents directly into the catalyst formulation or as additives to the polymerisation process typically leads to a suppression of the productivity of the catalyst, resulting in a decrease of process economics, or may affect the product properties of the polymer produced, for example it may negatively affect the density or the melt index of the polymer. It is believed that certain of these effects find their origin in interaction of the antistatic agent with the active species of the catalyst system. Therefore, a desire exists to develop a process for ethylene polymerisation in which an antistatic agent is employed wherein the occurrence of static charge formation is adequately reduced, whilst no interference with the polymerisation process itself occurs.

### SUMMARY

This is now provided according to the present invention by a process for the production of ethylene-based polymers, preferably via gas-phase polymerisation, wherein the process is performed by polymerisation of a reaction composition comprising ethylene in the presence of a catalyst system, an aluminium-containing cocatalyst, an aluminium-containing cocatalyst aid, and an antistatic compound comprising one or more moieties according to formula I:

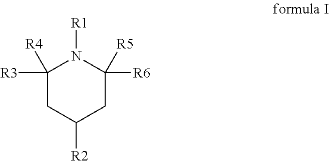

wherein:
R1 is H or an aliphatic moiety comprising 1 to 4 carbon atoms, preferably H or CH₃, more preferably H;
R4 and R5 are moieties comprising 1 to 10 carbon atoms, preferably aliphatic or aromatic moieties comprising 1 to 10 carbon atoms, more preferably —CH₂CH₃ or CH₃;
R3 and R6 are H or moieties comprising 1 to 10 carbon atoms, preferably aliphatic or aromatic moieties comprising 1 to 10 carbon atoms, more preferably —CH₂CH₃ or CH₃;
R2 is H; a moiety comprising 1 to 10 carbon atoms, preferably an amine, aliphatic or aromatic moiety comprising 1 to 10 carbon atoms; or R2 forms a linkage to a polymeric structure wherein the compound of formula I forms a functional moiety that is bound to a polymeric chain.

Such process allows for the production of ethylene-based polymers of desirable quality and at desirable productivity, whilst at the same time formation of static charges and sheet formation on the inner wall of polymerisation reactors are prevented.

### DETAILED DESCRIPTION

It is preferred that each of R3, R4, R5 and R6 are moieties comprising 1 to 10 carbon atoms, preferably aliphatic or aromatic moieties comprising 1 to 10 carbon atoms, more preferably —CH₂CH₃ or CH₃. Preferably, R1 is H.

The moiety of formula I may for example be a 2,2,6,6-tetramethyl piperidine moiety. The moiety of formula I may form part of a polymeric structure having repeating polymer units according to formula II:

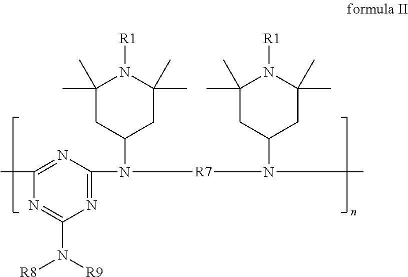

wherein:
R1 is H or an aliphatic moiety comprising 1 to 4 carbon atoms, preferably H or CH₃, more preferably H;
R7 is an alkyl moiety, preferably an alkyl moiety comprising 4 to 10 carbon atoms, more preferably a —(CH₂)ₓ— moiety wherein x is 4 to 10, preferably x is 6; and
each R8 and R9 is H; a moiety comprising 1 to 10 carbon atoms, preferably an aliphatic or aromatic moiety comprising 1 to 10 carbon atoms, more preferably n-butyl, t-butyl or t-octyl; 2,2,6,6-tetramethyl-4-piperidyl; or 4,6-bis(di-n-butylamino)-1,3,5-triazin-2-yl;
   and preferably wherein n≥1 and ≤10.

In this formula II, R8 may for example be H and R9 t-butyl or t-octyl; or R8 may be n-butyl and R9 2,2,6,6-tetramethyl-4-piperidyl.

Preferably, the antistatic compound has a molecular weight of ≥1000 and ≤5000 g/mol.

The antistatic compound may for example be a compound selected from 2,2,6,6-

tetramethyl-piperidine; 1,2,2,6,6-pentamethyl-piperidine; N,N′-bis(2,2,6,6-tetramethylpiperidin-4-yl) hexamethylene-1,6-diamine; bis(2,2,6,6-tetramethylpiperidin-4-yl) amine; N,N′-bis (2,2,6,6-tetramethylpiperidin-4-yl)-N,N′-dicyclohexyl-2-hydroxypropylene-1,3-diamine; 1-n-octyl-2,2,6,6-tetramethyl-piperidine; 1-benzyl-2,2,6,6-tetramethyl-piperidine; 2,6-di-tert-butyl-4-(1,2,2,6,6-pentamethyl-piperidin-4-ylmethyl)-phenol; dibutyl-(1,2,2,6,6-pentamethyl-piperidin-4-yl)-amine; N,N′,N″-tributyl-N,N′,N″-tris-(2,2,6,6-tetramethyl-piperidin-4-yl)-[1,3,5] triazine-2,4,6-triamine; 1-(but-3-enyl)-2,2,6,6-tetramethyl-piperidine; 2,2,6,6-tetramethyl-4-undec-10-enyl-piperidine; 1-(undec-10-enyl)-2,2,6,6-tetramethyl-piperidine; 4-(undec-10-enylamide)-1,2,2,6,6-pentamethylpiperidine; 4-((N-n-butyl)-undec-10-enylamide)-1,2,2,6,6-pentamethylpiperidine; 4-hydroxy-2,2,6,6-tetramethylpiperidine; 1-benzyl-4-hydroxy-2,2,6,6-tetramethylpiperidine; 4-stearoyloxy-2,2,6,6-tetramethylpiperidine; 1-ethyl-4-salicyloyloxy-2,2,6,6-tetramethylpiperidine; di(2,2,6,6-tetramethylpiperidin-4-yl)succinate; N,N′-bis(2,2,6,6-tetramethylpiperidin-4-yl) succinamide; hexane-1′,6′-bis(4-carbamoyloxy-1-n-butyl-2,2,6,6-tetramethylpiperidine); dimethylbis(2,2,6,6-tetramethylpiperidin-4-oxy)silane; 2-[n-butyl(1,2,2,6,6-pentamethyl-4-piperidinyl) amino]-4,6-bis (diethylamino)-1,3,5-triazine; 2,4,6-tris [ethyl(1,2,2,6,6-pentamethyl-4-piperidinyl) amino]-1,3,5-triazine; 2,4-bis [n-butyl (2,2,6,6-tetramethyl-4-piperidinyl)amino]-6-methyl-1,3,5-triazine; bis(2,2,6,6-tetramethyl-4-piperidyl)sebacate; and N,N″′-1,2-ethanediylbis [N-[3-[4,6-bis[butyl(1,2,2,6,6-pentamethyl-4-piperidinyl)amino]-1,3,5-triazin-2-yl]amino]propyl]-N′,N″-dibutyl-N′,N″-bis(1,2,2,6,6-pentamethyl-4-piperidinyl)-1,3,5-triazine-2,4,6-diamine.

Preferably, the antistatic compound is an oligomeric or polymeric compound comprising 2,2,6,6-tetramethylpiperidine moieties, for example selected from poly[[6-[(1,1,3,3-tetramethylbutyl) amino]-s-triazine-2,4-diyl]-[(2,2,6,6-tetramethyl-4-piperidyl)imino]-hexamethylene-[(2,2,6,6-tetramethyl-4-piperidyl)imino]]; poly-methylpropyl-3-oxy-4-(2,2,6,6-tetramethyl-piperidinyl-siloxane; poly[(6-morpholine-s-trizine-2,4-diyl)-(2,2,6,6-tetramethyl-4-piperidinyl) imino-hexamethylene-(2,2,6,6-tetramethyl-4-piperidinyl)imino]; poly[(6-cyclohexylamino-s-triazine-2,4-diyl]-[(2,2,6,6-tetramethyl-4-piperidyl)imino]-hexamethylene-[(2,2,6,6-tetramethyl-4-piperidyl)imino]]; and poly[(2,2,6,6-tetramethyl-4-piperidyl)imino)-propan-1,3-diyl].

The antistatic compound may, in addition to performing its antistatic function due to the presence of the amino functional group, also act to prevent sheeting by the adherence to the inner wall of the reactor, and the inner surfaces of feeding lines, recycle lines and other exposed surface in the interior of the polymerisation reactor system, thus forming a coating that prevents sheet formation. In particular, such coating effect appears to occur when using an oligomeric or polymeric compound as antistatic agent.

The cocatalyst aid may for example be an aluminium alkyl compound, preferably selected from trimethylaluminium, triethylaluminium, triisobutylaluminium, tri-n-hexylaluminium, tri-n-octylaluminium, diethylaluminium chloride, ethylaluminium dichloride, ethylaluminium sesquichloride and diethylaluminium ethoxide, more preferably from trimethylaluminium, triethylaluminium, triisobutylaluminium, tri-n-hexylaluminium and tri-n-octylaluminium, even more preferably the cocatalyst aid is triisobutylaluminium.

The molar ratio of the aluminium in the cocatalyst aid to the moieties of formula I in the antistatic compound may for example be >0.5 and <3.0, preferably >0.75 and <2.5, more preferably >1.0 and <2.5, even more preferably >1.5 and <2.5.

In certain embodiments of the invention, the cocatalyst and the antistatic agent may be provided to the polymerisation in the form of a mixture. Such mixture may be supplied in quantities of >0.1 and ≤10.0 wt %, with regard to the weight of the catalyst system, preferably ≥0.2 and ≤5.0 wt %, more preferably ≥0.2 and ≤2.0 wt %.

In certain embodiments of the invention, the cocatalyst aid and the antistatic agent may be provided to the polymerisation in the form of a mixture. Such mixture may be supplied in quantities of ≥0.1 and ≤10.0 wt %, with regard to the weight of the catalyst system, preferably >0.2 and ≤5.0 wt %, more preferably ≥0.2 and ≤2.0 wt %.

In certain embodiments of the invention, the cocatalyst and the antistatic agent may be provided to the catalyst system in the form of a mixture during the preparation of the catalyst. Such mixture may be supplied in quantities of ≥0.1 and ≤10.0 wt %, with regard to the weight of the catalyst system, preferably ≥0.2 and ≤5.0 wt %, more preferably ≥0.2 and ≤2.0 wt %.

In certain embodiments of the invention, the cocatalyst aid and the antistatic agent may be provided to the catalyst system in the form of a mixture during the preparation of the catalyst. Such mixture may be supplied in quantities of >0.1 and ≤10.0 wt %, with regard to the weight of the catalyst system, preferably ≥0.2 and ≤5.0 wt %, more preferably ≥0.2 and ≤2.0 wt %.

In further embodiments, the mixture of the cocatalyst and the antistatic agent may be added to the polymerisation reactor via injection through a monomer feed line, a conomomer feed line, or a recycle line. The mixture may supplied as a solution, and metered to the reactor using a sight/glass motor valve with an orifice feeding arrangement at a position above the distribution plate of the reactor. The mixture can be supplied continuously or intermittently, based on static charge monitoring by static probes. The amount of mixture added to the polymerisation reaction may for example be in the range of ≥1 and ≤1000 ppm by weight, with regard to the weight of the polymer product, preferably ≥1 and ≤5000 ppm, more preferably ≥10 and ≤200 ppm.

In further embodiments, the mixture of the cocatalyst aid and the antistatic agent may be added to the polymerisation reactor via injection through a monomer feed line, a conomomer feed line, or a recycle line. The mixture may supplied as a solution, and metered to the reactor using a sight/glass motor valve with an orifice feeding arrangement at a position above the distribution plate of the reactor. The mixture can be supplied continuously or intermittently, based on static charge monitoring by static probes. The amount of mixture added to the polymerisation reaction may for example be in the range of ≥1 and ≤1000 ppm by weight, with regard to the weight of the polymer product, preferably ≥1 and ≤5000 ppm, more preferably ≥10 and ≤200 ppm.

In an embodiment of the invention, the catalyst system, the aluminium-containing cocatalyst, the aluminium-containing cocatalyst aid, and the antistatic compound may be provided to the polymerisation in the form of a catalyst, wherein the catalyst is prepared by contacting the catalyst system, the cocatalyst, the cocatalyst aid and the antistatic compound.

In an embodiment, the invention also relates to a process involving preparing a catalyst by contacting the catalyst system, the cocatalyst, the cocatalyst aid and the antistatic compound, and polymerisation of a reaction composition comprising ethylene in the presence of the catalyst.

In an alternative embodiment, the antistatic agent may be pre-mixed with the catalyst system prior to addition thereof to the reactor.

The reaction composition preferably comprises ethylene and optionally one or more

comonomer selected from propylene, 1-butene, 1-pentene, 1-hexene, 4-methyl-1-pentene, and 1-octene; more preferably, the reaction composition comprises ethylene and optionally one or more comonomer selected from propylene, 1-butene, 1-hexene, and 1-octene.

The cocatalyst is preferably selected from a methylaluminoxane, a borane or borate compound, preferably from methylaluminoxane, perfluorophenylborane, triethylammonium tetrakis(pentafluorophenyl) borate, triphenylcarbenium tetrakis(pentafluorophenyl)borate, trimethylsilyl tetrakis(pentafluorophenyl)borate, 1-pentafluorophenyl-1,4-dihydroboratabenzene, tributylammonium 1,4-bis(pentafluorophenyl)boratabenzene, and triphenylcarbenium 1-methylboratabenzene, more preferably the cocatalyst is methylaluminoxane.

The catalyst system may for example be a single-site catalyst system, preferably a metallocene-type catalyst system; a Ziegler-Natta type catalyst system; or a chromium-containing Phillips-type catalyst system.

Preferably, the catalyst system is a metallocene-type catalyst system, preferably comprising a compound selected from [2,2′-bis(2-indenyl)biphenyl]zirconium dichloride; [2,2′-bis(2-indenyl)biphenyl]hafnium dichloride; [2,2′-bis(1-indenyl)biphenyl]zirconium dichloride; [2,2′-bis(1-indenyl)biphenyl]hafnium dichloride; [(2-(2-indenyl)-2′-cyclopentadienyl)biphenyl]zirconium dichloride; [(2-(2-indenyl)-2′-cyclopentadienyl)biphenyl]hafnium dichloride; [1,2-bis(2-indenyl)phenyl]zirconium dichloride; [1,2-bis(2-indenyl)phenyl]hafnium dichloride; [2,2′-bis(5-phenyl-2-indenyl)biphenyl]zirconium dichloride; [2,2′-bis(5-phenyl-2-indenyl) biphenyl]hafnium dichloride; [2,2′-bis(4,7-dimethyl-2-indenyl)biphenyl]zirconium dichloride; [2,2′-bis(4,7-dimethyl-2-indenyl) biphenyl]hafnium dichloride; [2,2′-bis(4-fluoro-2-indenyl)biphenyl]zirconium dichloride; [2,2′-bis(4-fluoro-2-indenyl)biphenyl]hafnium dichloride; [2,2′-bis(5,7-ditertiarybutyl-2-indenyl)biphenyl]zirconium dichloride; [2,2′-bis(5,7-ditertiarybutyl-2-indenyl)biphenyl]hafnium dichloride; dichloro[[(1,2,3,3a,7a-n)-2-(1-methylethyl)-1H-inden-1-ylidene] (dimethylsilylene)[(1,2,3,4,5-n)-2,3,4,5-tetramethyl-2,4-cyclopentadien-1-ylidene]]-zirconium; dichloro[[(1,2,3,3a,7a-n)-2-phenyl-1H-inden-1-ylidene](dimethylsilylene)[(1,2,3,4,5-n)-2,3,4,5-tetramethyl-2,4-cyclopentadien-1-ylidene]]-zirconium; dichloro[[(1,2,3,3a,7a-n)-2-methyl-4-phenyl-1H-inden-1-ylidene](dimethylsilylene)[(1,2,3,4,5-n)-2,3,4,5-tetramethyl-2,4-cyclopentadien-1-ylidene]]-zirconium; dichloro[[(1,2,3,3a,7a-n)-3-phenyl-1H-inden-1-ylidene](dimethylsilylene)[(1,2,3,4,5-n)-2,3,4,5-tetramethyl-2,4-cyclopentadien-1-ylidene]]-zirconium; dichloro[[(1,2,3,3a,7a-n)-2-phenyl-3-methyl-1H-inden-1-ylidene](dimethylsilylene)[(1,2,3,4,5-n)-2,3,4,5-tetramethyl-2,4-cyclopentadien-1-ylidene]]-zirconium; dichloro[[(1,2,3,3a,7a-n)-2-phenyl-1H-inden-1-ylidene](dimethylsilylene)[(1,2,3,3a,7a-n)-1H-inden-2-ylidene]]-zirconium; dichloro[[(1,2,3,3a,7a-n)-2-(3,5-dimethylphenyl)-1H-inden-1-ylidene](dimethylsilylene)[(1,2,3,3a,7a-n)-1,3-dimethyl-1H-inden-2-ylidene]]-zirconium; [[(1,2,3,3a,7a-n)-2-(1-methylethyl)-1H-inden-1-ylidene](dimethylsilylene)[(1,2,3,4,5-n)-2,3,4,5-tetramethyl-2,4-cyclopentadien-1-ylidene]]-hafnium; and dichloro[[(1,2,3,3a,7a-n)-2-phenyl-1H-inden-1-ylidene](dimethylsilylene)[(1,2,3,4,5-n)-2,3,4,5-tetramethyl-2,4-cyclopentadien-1-ylidene]]-hafnium.

The catalyst system may for example be a supported catalyst system, preferably the support material may be selected from silica, alumina, magnesia, titania, zirconia, clay, zeolite, polystyrene, polyethylene, polypropylene, polyvinylchloride, polycarbonate, polyketone, polyvinylalcohol, polymethyl methacrylate, cellulose, and graphite, more preferably the support material is silica.

Such silica preferably is a fine particulate having a large specific surface area, preferably between 50 and 500 m2/g, and a high pore volume, preferably between 0.5 and 2.0 cm³/g. The mean particle diameter of the silica may for example be between 3 and 20 μm, if the catalyst is to be employed in a solution polymerisation process; or between 30 and 100 μm, if the catalyst is to be employed in a gas phase polymerisation process; or between 5 and 80 μm, if the catalyst is to be employed in a slurry polymerisation process.

Before immobilisation of the metallocene precursor on the silica, the silica typically is to be treated at high temperature, such as at a temperature of between 450° C. and 700° C., under nitrogen flow, in a fluidised bed reactor, for several hours, such as for between 3 and 6 hours.

The molar ratio of the cocatalyst to the metallocene in the catalyst system may for example be ≥1.0 and ≤1000, preferably ≥50.0 and ≤300.0, in case that the cocatalyst is an organoaluminium compound; and may for example be ≥1.0 and ≤50.0, preferably ≥1.0 and ≤10.0, in case that the cocatalyst is a non-coordinating anionic compound.

It is preferred that the catalyst system comprises ≥6.0 and ≤30.0 wt % of Al, preferably ≥7.0 and ≤17.0 wt %, more preferably ≥10.0 and ≤16.0 wt %, with regard to the total weight of the catalyst system. It is preferred that the catalyst system comprises ≥0.10 and ≤1.00 wt % of Zr or Hf, preferably ≥0.15 and ≤0.50 wt %, more preferably ≥0.15 and ≤0.30 wt %, with regard to the total weight of the catalyst system.

The process may for example be performed at a pressure of ≥10 and ≤80 MPa, preferably ≥20 and ≤60 MPa, and at a temperature of ≥40 and ≤100° C., preferably at ≥60 and ≤90° C., more preferably at ≥60 and ≤85° C.

The process may for example be a slurry polymerisation process, a solution polymerisation process, a gas-phase polymerisation process, a bulk polymerisation process, or a combination thereof. Preferably, the process is a gas-phase polymerisation process. It is particularly preferred that such gas-phase polymerisation process is operated in condensing mode or supercondensing mode.

The ethylene-based polymers that may be produced according to the process of the present invention may for example be homopolymers or copolymers. Such ethylene-based copolymers may be polymers comprising moieties derived from ethylene and moieties derived from a comonomer compound selected from propylene, 1-butene, 1-pentene, 1-hexene, 4-methyl-1-pentene, and 1-octene, preferably from 1-butene, 1-hexene and 1-octene. Such copolymer may for example comprise ≥0.2 and ≤30.0 wt % of moieties derived from the comonomer compound, with regard to the total weight of the ethylene-based polymer, preferably ≥1.0 and ≤25.0, more preferably ≥5.0 and ≤20.0 wt %. Such ethylene-based copolymer may alternatively be a terpolymer comprising moieties derived from ethylene; a first comonomer compound selected from propylene, 1-butene, 1-pentene, 1-hexene, 4-methyl-1-pentene, and 1-octene, preferably from 1-butene, 1-hexene and 1-octene; and a second comonomer compound selected from propylene, 1-butene, 1-pentene, 1-hexene, 4-methyl-1-pentene, and 1-octene, preferably from 1-butene, 1-hexene and 1-octene, wherein the first comonomer compound is different from the second comonomer compound. Such terpolymer may for example comprise ≥5.0 and ≤50.0 wt % of moieties derived from the first and the second comonomer compound, with regard to the total weight of the ethylene-based polymer, preferably ≥10.0 and ≤30.0, more preferably ≥10.0 and ≤25.0 wt %.

The ethylene-based polymers that may be produced using the process according to the present invention may for example have a density of ≥0.850 and ≤0.975 g/cm³. For example, the ethylene-based polymers may be ethylene-based elastomers (POE) or plastomers (POP) having a density of ≥0.850 and ≤0.905 g/cm³, or linear low-density polyethylenes (LLDPE) having a density of ≥0.906 and ≤0.925 g/cm³, or linear medium-density polyethylenes (MDPE) having a density of ≥0.926 and ≤0.940 g/cm³, or high-density polyethylenes (HDPE) having a density of ≥0.941 and ≤0.975 g/cm³. The density may be determined in accordance with ASTM D792 (2008).

The ethylene-based polymers may for example have a melt mass-flow rate as determined in accordance with ISO 1133:2005 at 190° C. and 2.16 kg load of ≥0.1 and ≤50.0 g/10 min, preferably ≥ 0.5 and ≤ 30.0 g/10 min, more preferably ≥1.0 and ≤10.0 g/10 min, even more preferably ≥1.0 and ≤5.0 g/10 min.

In the context of the present invention, the terms antistatic agent and antistatic compound are interchangeable.

The invention will now be illustrated by the following non-limiting examples.

The process of the invention is now demonstrated by polymerisation experiments as described below. In table 1, the materials that were used in the polymerisation experiments are presented.

TABLE 1

| | |
|---|---|
| Metallocene | [2,2′-bis(2-indenyl)biphenyl]zirconium dichloride, CAS |
| | reg. nr. 312968-31-3, obtainable from Innovasynth |
| | Technologies |
| Support | Silica 955, obtainable from W. R. Grace & Co |
| Cocatalyst | Methyl aluminoxane (MAO), CAS reg. nr. 29429-58-1, |
| | obtainable from W. R. Grace & Co |
| Cocatalyst | Triisobutyl aluminium (TIBAL), CAS reg. nr. 100-99-2, |
| aid | obtainable from Sigma-Aldrich |

Antistatic agents

| | |
|---|---|
| AA1 | Cyclohexylamine, CAS reg. nr. 108-91-8, obtained from |
| | Sigma-Aldrich |
| AA2 | Chimassorb ® 944, poly[[6-[(1,1,3,3- |
| | tetramethylbutyl)amino]-1,3,5-triazine-2,4- |
| | diyl][(2,2,6,6-tetramethyl-4-piperidinyl)imino]-1,6- |
| | hexanediyl[(2,2,6,6-tetramethyl-4-piperidinyl)imino]], |
| | CAS reg. nr. 71878-19-8, obtainable from BASF |
| AA3 | Chimassorb ® 2020, CAS reg. nr. 192268-64-7, |
| | obtainable from BASF |

All materials were handled in a nitrogen atmosphere using either Schlenk techniques or a nitrogen filled glove box. Nitrogen and isopentane were dried through an additional bed of molecular sieves. All other solvents were first dried over molecular sieves and sodium/potassium amalgam. The catalysts were prepared using temperature controlled to within 0.5° C. in a silicon oil bath with stirring. Chimassorb® 944 and Chimassorb® 2020 were dried under vacuum at 80° C. for 12 h.

### Preparation of Mixtures of Cocatalyst Aid and Antistatic Agent

A range of mixtures comprising TIBAL and antistatic agents were prepared according to the method below, using the materials and quantities of such materials as presented in table 2.

To a 50 ml vial, 15 ml of hexane was charged in a glovebox under nitrogen atmosphere. The quantity of TIBAL was added to the vial, followed by slow addition of the given quantity of the listed antistatic agent, at room temperature. The obtained solution contained 1M of TIBAL.

The mixtures of the examples A15, A16 and A17 were prepared according to the methods of the examples A2, A5 and A10, respectively, however further followed by heating the mixtures at 70° C. for 4 hrs, to investigate the effect of temperature on the performance of the mixtures.

TABLE 2

| | | | | Molar | |
|---|---|---|---|---|---|
| | Quantity | Antistatic | Quantity | ratio | |
| | TIBAL | agent | AA | TIBAL/ | Appearance |
| Example | (g) | (AA) | (g) | AA | of solution |
| A1 | 3.93 | — | — | 1:0 | Colourless |
| A2 | 3.93 | AA1 | 0.65 | 3:1 | Colourless |
| A3 | 3.93 | AA1 | 0.98 | 2:1 | Colourless |
| A4 | 3.93 | AA1 | 1.96 | 1:1 | Colourless |
| A5 | 3.93 | AA2 | 1.15 | 3:1 | Colourless |
| A6 | 3.93 | AA2 | 1.72 | 2:1 | Colourless |
| A7 | 3.93 | AA2 | 3.45 | 1:1 | Light yellow |
| A8 | 3.93 | AA2 | 6.90 | 1:2 | Light yellow |
| A9 | — | AA2 | 6.90 | 0:1 | Light yellow |
| A10 | 3.93 | AA3 | 1.88 | 3:1 | Colourless |
| A11 | 3.93 | AA3 | 2.82 | 2:1 | Colourless |
| A12 | 3.93 | AA3 | 5.65 | 1:1 | Light yellow |
| A13 | 3.93 | AA3 | 11.30 | 1:2 | Light yellow |
| A14 | — | AA3 | 11.30 | 0:1 | Light yellow |
| A15 | 3.93 | AA1 | 0.65 | 3:1 | Colourless |
| A16 | 3.93 | AA2 | 1.15 | 3:1 | Colourless |
| A17 | 3.93 | AA3 | 1.88 | 3:1 | Colourless |

In table 2, the molar ratio TIBAL/AA denotes the molar ratio of TIBAL to the amino functional group(s) of the antistatic agent. As per the respective molecular structures, AA1, AA2 and AA3 contain 1 mole of amino functional groups per 99 g, 174 g and 285 g, respectively.

Example A1 represents a cocatalyst aid solution without any antistatic agent, and was provided for comparative purposes to demonstrate the productivity of the catalyst without being affected by the presence of antistatic agent.

### Preparation of Supported Metallocene Complexes

### Catalyst BO

A 3-liter autoclave reactor equipped with a heating/cooling control unit and a mechanical stirring system was baked at 150° C. (inlet oil) under a nitrogen flow for 2 hours and then cooled down to 30° C. 200 g of Grace Silica 955 pre-dehydrated at 600° C. for 10 hours was charged followed by addition of 800 ml of toluene. 3.32 g of [2,2′-bis(2-indenyl)biphenyl]zirconium dichloride was activated by mixing with 1203.6 ml of a 10 wt % MAO toluene solution at 50° C. for 30 min to obtain an activated metallocene. The activated metallocene was transferred into the autoclave reactor with stirring. The antistatic reagent modifier was prepared by reacting 0.31 g of cyclohexylamine and 0.62 g of triisobutylaluminum in 200 ml of toluene, added to the autoclave, and the reaction mixture was stirred at 95° C. for 5 hours. After drying at 75° C. under vacuum (13.5 kPa), the finished catalyst was isolated as light-yellow free-flowing powder. The catalyst contained 0.18 wt % of Zr and 16.0 wt % of Al. This resulted in a molar ratio of Al/Zr of about 300.

### Catalysts B1-B13

2.5 g of a Grace Silica 955 support that had been pre-dehydrated at 600° C. for 4 hrs was charged into a 100 ml two-neck Schlenk flask in a glovebox under nitrogen atmosphere, followed by the addition of 15 ml of toluene. After shaking, a suspension was obtained. 0.042 g of the metallocene was activated by mixing it with 15.2 ml of a 10 wt % solution of the cocatalyst in toluene in a 25 ml vial at room temperature for 10 min in the glovebox, also under nitrogen atmosphere, to obtain an activated metallocene mixture. The activated metallocene mixture was transferred into the suspension. Given amounts of cocatalyst aid and antistatic agent as presented in table 3 below were mixed in 10 ml of toluene in another 25 ml vial, at room temperature for 10 min in the glovebox, and then transferred into the suspension. The final mixture was heated to 95° C. and maintained at hat temperature for 5 hrs. Subsequently, the product was dried at 75° C. under vacuum to obtain the supported catalyst, which was isolated as free-flowing powder. The supported catalysts each contained 0.18 wt % of Zr and 16.0 wt % of

Al, which translates to a molar ratio of Al to Zr of ca. 300. The molar ratio of TIBAL to the amino functional group(s) of the antistatic agent in each of the examples B2-B13 was 1:1.

TABLE 3

| | Quantity | Antistatic | Quantity | Molar |
|---|---|---|---|---|
| | TIBAL | agent | AA | ratio |
| Example | (g) | (AA) | (g) | Zr/AA |
| B1 | — | — | — | 1:0 |
| B2 | 0.0075 | AA1 | 0.0038 | 1:0.5 |
| B3 | 0.015 | AA1 | 0.0076 | 1:1 |
| B4 | 0.0375 | AA1 | 0.019 | 1:2.5 |
| B5 | 0.075 | AA1 | 0.038 | 1:5 |
| B6 | 0.0079 | AA2 | 0.0071 | 1:0.5 |
| B7 | 0.0155 | AA2 | 0.0136 | 1:1 |
| B8 | 0.0388 | AA2 | 0.0342 | 1:2.5 |
| B9 | 0.0776 | AA2 | 0.0684 | 1:5 |
| B10 | 0.0075 | AA3 | 0.0108 | 1:0.5 |
| B11 | 0.015 | AA3 | 0.022 | 1:1 |
| B12 | 0.0375 | AA3 | 0.055 | 1:2.5 |
| B13 | 0.075 | AA3 | 0.11 | 1:5 |

In table 3, the molar ratio Zr/AA denotes the molar ratio of zirconium in the metallocene to the amino functional group(s) of the antistatic agent.

### Polymerisation Experiments

### Effects of Using Mixtures of Cocatalyst Aid and Antistatic Agent

To establish the effect of the use of the mixtures of the cocatalyst aids and the antistatic

agents as prepared in examples A1-A17, a set of polymerisation experiments was conducted using catalyst BO. The polymerisation experiments were conducted via slurry polymerisation.

A 1.6 l stainless steel reactor vessel, equipped with a helical stirrer and a heating/cooling control unit, was heated to 110° C. at a nitrogen flow rate of 100 g/h for 2 hrs. After that, the reactor was pressure purged with nitrogen, followed by a purge with ethylene. This purging cycle was repeated three times.

The reactor was then cooled to 88° C. under ethylene pressure of 10 bar. After venting, 100 ml of hexane was added via a cocatalyst injection pump, followed by addition of 4 ml of the cocatalyst aid/antistatic mixture. The particular mixture that was used for each polymerisation experiment is presented in table 4 below. Nitrogen was introduced to maintain a nitrogen pressure of 7 bar. Ethylene was then introduced to the reactor under control of mass flow parameters to maintain an ethylene pressure in the reactor of 10 bar. Upon reaching a stable level of temperature and pressure, 25 mg of catalyst B0 was injected via a catalyst injection pump upon which the reaction started. After 1 hr, the ethylene supply was discontinued and the reactor was cooled to 40° C. The reactor was opened after venting. The polyethylene product that was formed in the reactor was collected to a sample tray, and dried at ambient temperature under atmospheric pressure. The results from polymerisation are presented in table 4.

TABLE 4

| | Cocatalyst / | PE yield | PE productivity |
|---|---|---|---|
| Example | AA mixture | (g) | (g PE / g cat) |
| C1 | A1 | 58.0 | 2320 |
| C2 | A2 | 28.6 | 1143 |
| C3 | A3 | 6.8 | 270 |
| C4 | A4 | 0 | 0 |
| C5 | A5 | 58.2 | 2329 |
| C6 | A6 | 27.3 | 2290 |
| C7 | A7 | 55.1 | 2203 |
| C8 | A8 | 30.4 | 1216 |
| C9 | A9 | 1.5 | 60 |
| C10 | A10 | 50.2 | 2008 |
| C11 | A11 | 49.6 | 1984 |
| C12 | A12 | 38.5 | 1540 |
| C13 | A13 | 30.9 | 1234 |
| C14 | A14 | 1.5 | 60 |
| C15 | A15 | 43.8 | 1750 |
| C16 | A16 | 57.1 | 2282 |
| C17 | A17 | 46.4 | 1857 |

It can be seen that in the examples C2-C4, using the antistatic agent AA1, the catalyst productivity significantly drops with increase of the amount of the antistatic agent. The same tendency can be observed in the examples C10-C14, wherein the antistatic agent AA3 is used. However, in the examples C5-C9, in which the antistatic agent AA2 is used, the catalyst did not vary substantially with increase of the amount of the antistatic agent, in particular for the examples wherein the ratio of TIBAL to the antistatic agent was in the range of 3:1 to 1:1.

When considering the effect of the thermal treatment in examples A15-A17 to the mixtures of A2, A5 and A10, it can be observed that in example C15, compared to C2, the catalyst productivity is increased, whereas in the example C16 (compared to C5) and C17 (compared to C10), the catalyst productivity is fairly comparable.

In the examples where an antistatic agent was used, no sheeting was observed.

### Effects of Using Antistatic Agents Added During Catalyst Synthesis

The effects of the use of various mixtures of cocatalyst aid and antistatic agents as part of the catalytic systems, as prepared in the examples B1-B13, in ethylene polymerisation was investigated by conducting a multitude of polymerisation experiments in gas phase.

A 1.6 l stainless steel reactor vessel, equipped with a helical stirrer and a heating/cooling control unit, was heated to 110° C. at a nitrogen flow rate of 100 g/h for 2 hrs. After that, the reactor was pressure purged with nitrogen, followed by a purge with ethylene. This purging cycle was repeated three times.

The reactor was then cooled to 88° C. under ethylene pressure of 10 bar. After venting, 4 ml of AXION PA 4276, obtainable from Lanxess, was added via a cocatalyst injection pump. Nitrogen was introduced to maintain a nitrogen pressure of 8 bar. Ethylene was then introduced to the reactor under control of mass flow parameters to maintain an ethylene pressure in the reactor of 10 bar. Upon reaching a stable level of temperature and pressure, 40 mg of catalyst was injected via a catalyst injection pump, upon which the reaction started. The catalyst as used for each of the examples is presented in table 5 below. After 1 hr, the ethylene supply was discontinued and the reactor was cooled to 40° C. The reactor was opened after venting. The polyethylene product that was formed in the reactor was collected to a sample tray, and dried at ambient temperature under atmospheric pressure. The results from polymerisation are presented in table 5.

TABLE 5

| | | PE yield | PE productivity |
|---|---|---|---|
| Example | Catalyst | (g) | (g PE / g cat) |
| D1 | B1 | 53.6 | 1341 |
| D2 | B2 | 52.6 | 1315 |
| D3 | B3 | 50.6 | 1266 |
| D4 | B4 | 50.4 | 1259 |
| D5 | B5 | 47.2 | 1179 |
| D6 | B6 | 52.8 | 1320 |
| D7 | B7 | 50.2 | 1256 |
| D8 | B8 | 48.4 | 1210 |
| D9 | B9 | 48.2 | 1206 |
| D10 | B10 | 55.6 | 1389 |
| D11 | B11 | 51.4 | 1284 |
| D12 | B12 | 49.5 | 1237 |
| D13 | B13 | 51.2 | 1281 |

It can be observed that with increase of the amount of the mixture of TIBAL and antistatic agent, the catalyst activity drops gradually, but not significantly. It was observed that for all the antistatic agents, the presence of the mixture of TIBAI and the antistatic agent in the catalyst may function as antistatic agent and scavenger, without substantially impacting the catalyst productivity.

In the examples where an antistatic agent was used, no sheeting was observed.

1. A process for the production of ethylene-based polymers, wherein the process is performed by polymerisation of a reaction composition comprising ethylene in the presence of a catalyst system, an aluminium-containing cocatalyst, an aluminium-containing cocatalyst aid, and an antistatic compound comprising one or more moieties according to formula I: 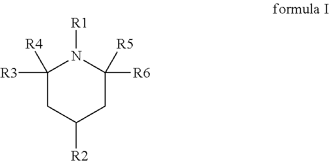
wherein:
R1 is H or an aliphatic moiety comprising 1 to 4 carbon atoms;
R4 and R5 are moieties comprising 1 to 10 carbon atoms;
R3 and R6 are H or moieties comprising 1 to 10 carbon atoms;
R2 is H; a moiety comprising 1 to 10 carbon atoms; or R2 forms a linkage to a polymeric structure wherein the compound of formula I forms a functional moiety that is bound to a polymeric chain.

2. The process according to claim 1, wherein the process is a gas-phase polymerisation process.

3. The process according to claim 1, wherein R1 is H.

4. The process according to claim 1, wherein the moiety of formula I is a 2,2,6,6-tetramethyl piperidine moiety.

5. The process according to claim 1, wherein the moiety of formula I forms part of a polymeric structure having repeating polymer units according to formula II: 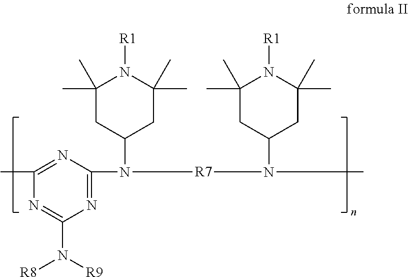
wherein:
R1 is H or an aliphatic moiety comprising 1 to 4 carbon atoms;
R7 is an alkyl moiety; and
each R8 and R9 is H; a moiety comprising 1 to 10 carbon atoms.

6. The process according to claim 5, wherein:
R8 is H and R9 is t-butyl or t-octyl; or
R8 is n-butyl and R9 is 2,2,6,6-tetramethyl-4-piperidyl.

7. The process according to claim 1, wherein the cocatalyst aid is an aluminium alkyl compound.

8. The process according to claim 1, wherein the molar ratio of the aluminium in the cocatalyst aid to the moieties of formula I in the antistatic compound is >0.5 and <3.0.

9. The process according to claim 1, wherein the cocatalyst aid and the antistatic agent are provided to the polymerisation in the form of a mixture.

10. The process according to claim 1, wherein the catalyst system, the aluminium-containing cocatalyst, the aluminium-containing cocatalyst aid, and the antistatic compound are provided to the polymerisation in the form of a catalyst, wherein the catalyst is prepared by contacting the catalyst system, the cocatalyst, the cocatalyst aid and the antistatic compound.

11. The process according to claim 1, wherein the reaction composition comprises ethylene and optionally one or more comonomer selected from propylene, 1-butene, 1-pentene, 1-hexene, 4-methyl-1-pentene, and 1-octene.

12. The process according to claim 1, wherein the cocatalyst is selected from a methylaluminoxane, a borane or borate compound.

13. The process according to claim 1, wherein:
the catalyst system is a single-site catalyst system; a Ziegler-Natta type catalyst system; or a chromium-containing Phillips-type catalyst system.

14. The process according to claim 1, wherein the catalyst system is a metallocene-type catalyst system.

15. The process according to claim 1, wherein the catalyst system is a supported catalyst system.
